(19) United States
(12) Patent Application Publication
(10) Pub. No.: US 2018/0224036 A1
(43) Pub. Date: Aug. 9, 2018

(54) HIGH TEMPERATURE HOSE FITTINGS

(71) Applicant: Parker-Hannifin Corporation, Cleveland, OH (US)

(72) Inventor: Nagarajan Ramaswamy, Fort Worth, TX (US)

(21) Appl. No.: 15/891,549

(22) Filed: Feb. 8, 2018

Related U.S. Application Data
(60) Provisional application No. 62/456,147, filed on Feb. 8, 2017.

(51) Int. Cl. F16L 33/207; F16L 33/00; F16L 33/18

(52) U.S. Cl. CPC F16L 33/2076; F16L 11/125; F16L 33/18; F16L 33/003

(57) ABSTRACT

A hose fitting and a method of manufacturing includes a main fitting body and an outer sleeve that surrounds the main fitting body. An axially extending nipple is formed on the main fitting body and a crimped region is defined by the main fitting body and the outer sleeve being crimped toward each other. A tube member is radially interposed between the main fitting body and the outer sleeve, and a low temperature sealing region is defined by the tube member being compressed over a grooved portion of the nipple. An elastomeric seal member is radially interposed between the main fitting body and the tube member, and a high temperature sealing region is defined by the tube member being compressed over the seal member. The crimped region, the low temperature sealing region, and the high temperature sealing region are sequentially arranged in an axial direction.

### RELATED APPLICATIONS

This application claims the benefit of U.S. Provisional Application No. 62/456,147 filed Feb. 8, 2017, which is hereby incorporated herein by reference.

### FIELD OF INVENTION

The present invention relates to hoses and more particularly, relates to hose fittings for use in high-temperature applications.

### BACKGROUND

Various applications may use hoses that are subject to high temperatures. For example, hoses may be used in aircraft engines having continuous high-temperature fluid operating conditions. The high-temperature operating conditions include both the ambient hose environment temperature and the temperature of the fluid flowing through the hose. Conventional hoses may not be suitable for withstanding high ambient temperatures or high fluid temperatures. For example, conventional hoses may fail or burst when subjected to the high temperature conditions.

Prior attempts to provide a hose assembly for use in high temperature applications have included also providing cooling components, such as cooling manifolds, heat shields, and mounting hardware. However, providing additional structural components may be disadvantageous in some applications due to space constraints and weight considerations. Such considerations are particularly significant when the hose is used in an aircraft engine. Providing the additional cooling components may also require complex manufacturing and increased costs.

### SUMMARY OF INVENTION

The present invention is directed toward a high temperature hose fitting having a low temperature sealing region, a high temperature sealing region, and a crimped region that are sequentially arranged along a longitudinal axis of the hose fitting. The sequential order may be dependent on the pressure and temperature of the environment for a given application in which the hose fitting is implemented. The hose fitting includes a tube member that is radially interposed between a main fitting body and an outer sleeve, and an elastomeric seal member that is radially interposed between the main fitting body and the tube member.

The low temperature sealing region provides low temperature sealing and is defined by the region in which the tube is compressed over a grooved nipple of the main fitting body. The high temperature sealing region provides high temperature sealing and is defined by the region in which the tube is compressed over the elastomeric seal member. The crimped region enables the hose fitting to withstand crimp pressure and end load conditions and is defined by a region in which the main fitting body and the outer sleeve are crimped toward each other. Using the sequentially arranged regions is advantageous by enabling use of the hose fitting in applications having high ambient temperatures and fluid temperatures.

According to an aspect of the invention, a hose fitting includes a main fitting body defining a fluid passage and an outer sleeve that surrounds at least a portion of the main fitting body. A crimped region is defined by the main fitting body and the outer sleeve being crimped toward each other. A nipple having a grooved portion is provided. A tube member is radially interposed between the main fitting body and the outer sleeve, and a low temperature sealing region is defined the tube member being compressed over the grooved portion of the nipple. An elastomeric seal member is radially interposed between the main fitting body and the tube member, and a high temperature sealing region is defined by the tube member being compressed over the elastomeric seal member. The crimped region, the low temperature sealing region, and the high temperature sealing region are sequentially arranged in an axial direction.

According to another aspect of the invention, a hose fitting includes a main fitting body defining an interior fluid passage and having an exterior surface, and the exterior surface has a nipple groove and at least one gland axially spaced from the nipple groove. The hose fitting includes an outer sleeve arranged around at least a portion of the main fitting body, the outer sleeve surrounding the nipple groove and the at least one gland. The hose fitting includes a tube member radially interposed between the main fitting body and the outer sleeve, and the tube member extends over the at least one gland. A low temperature sealing region is defined by compression of the tube member over the axially extending nipple. At least one elastomeric o-ring is arranged within the at least one gland, and a high temperature sealing region is defined by compression of the tube member over the at least one elastomeric o-ring. The hose fitting includes a braided metal wire radially interposed between the tube member and the outer sleeve, and a crimped region is axially interposed between the lower temperature sealing region and the high temperature sealing. The crimped region is defined by the outer sleeve, the first body hose and the braided metal wire being crimped together.

According to another aspect of the invention, a hose fitting includes a main fitting body defining an interior fluid passage and having an exterior surface, and the exterior surface has a nipple groove and at least one shallow recess axially spaced from the nipple groove. The hose fitting includes an outer sleeve arranged around at least a portion of the main fitting body, the outer sleeve surrounding the nipple groove and the at least one shallow recess. The hose fitting includes a tube member radially interposed between the main fitting body and the outer sleeve, the tube member extending over the at least one shallow recess, wherein a low temperature sealing region is defined by compression of the tube member over the axially extending nipple. At least one gasket is arranged within the at least one shallow recess, and a high temperature sealing region is defined by compression of the tube member over the at least one gasket. A braided metal wire is radially interposed between the tube member and the outer sleeve. A crimped region is defined by the outer sleeve, the first body hose and the braided metal wire being crimped together, and the high temperature sealing region is axially interposed between the crimped region and the low temperature sealing region.

A method of manufacturing a hose fitting includes providing a main fitting body having an nipple, forming a grooved surface and at least one gland on the nipple, securing an outer sleeve to the main fitting body, radially interposing a tube member between the main fitting body and the outer sleeve, inserting an elastomeric sealing member in the at least one gland, compressing the tube member over the nipple to form a low temperature sealing region over the grooved surface and a high temperature sealing region over the at least one gland, and crimping the main fitting body and the outer sleeve to form a crimped region. The low temperature sealing region, the high temperature sealing region, and the crimped region are sequentially arranged in an axial direction.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a schematic drawing showing a cross-sectional view of a hose fitting according to a first embodiment.

FIG. 2 is a schematic drawing showing a cross-sectional view of the hose fitting as shown in FIG. 1 and further including a gland that is face-seal shaped.

FIG. 3 is a schematic drawing showing an isometric view of a hose fitting according to a second embodiment in which the hose fitting includes a thin film tape layer.

FIG. 4 is a schematic drawing showing a cross-sectional view of the hose fitting shown in FIG. 3.

FIG. 5 is a schematic drawing showing another cross-sectional view of the hose fitting shown in FIG. 3.

FIG. 6 is a schematic drawing showing a cross-sectional view of a hose fitting according to a third embodiment in which the hose fitting includes a flat gasket seal.

FIG. 7 is a schematic drawing showing another cross-sectional view of the hose fitting shown in FIG. 6.

FIG. 8 is a schematic drawing showing a cross-sectional view of a hose fitting according to a fourth embodiment in which the hose fitting includes a flat gasket seal and a thin film tape layer.

FIG. 9 is a schematic drawing showing a cross-sectional view of a hose fitting according to a fifth embodiment in which the hose fitting includes a corrugated gasket seal and a corrugated ferrule.

FIG. 10 is a schematic drawing showing a detailed view of the hose fitting shown in FIG. 9.

### DETAILED DESCRIPTION

Aspects of the present invention relate to a hose fitting and a method of manufacturing a hose fitting having multiple varying temperature sealing regions that are sequentially arranged along the longitudinal axis of the hose fitting. The hose fitting may be configured as a self-contained, single component that contains the varying temperature sealing regions and may be connected to a hose assembly.

The hose fitting disclosed herein may be used in high temperature applications, such as in aircraft engines. The hose fitting may be suitable for applications having a continuous fluid operating temperature of over 500 degrees Fahrenheit and an environmental temperature of over 500 degrees Fahrenheit. The hose fitting may be suitable to withstand high temperatures of over 550 degrees Fahrenheit. The hose fitting may also be suitable for low temperature applications and may withstand low temperatures of around −65 degrees Fahrenheit. The hose fitting may be suitable for many other applications and temperature conditions.

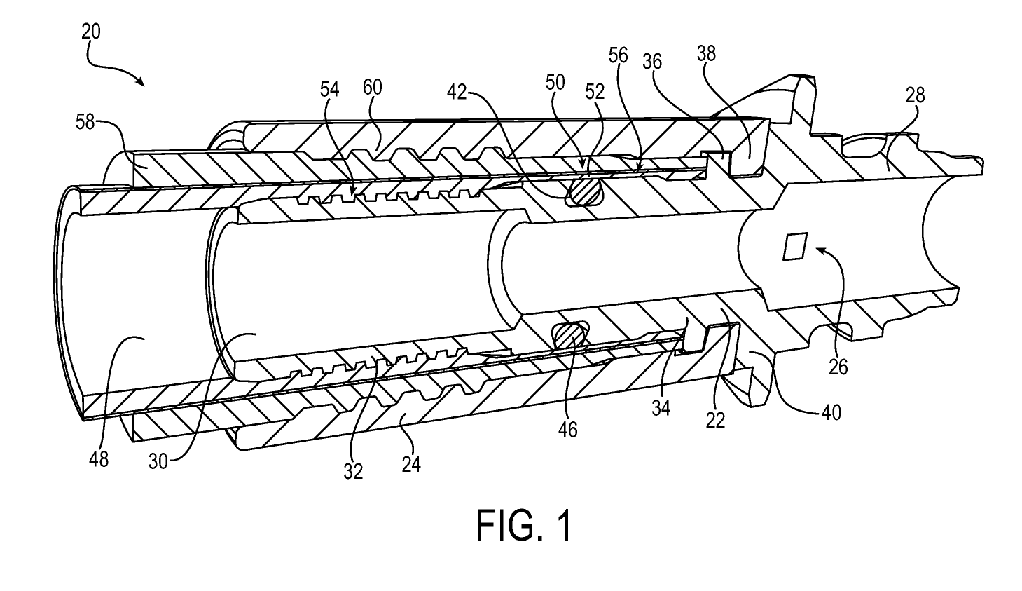

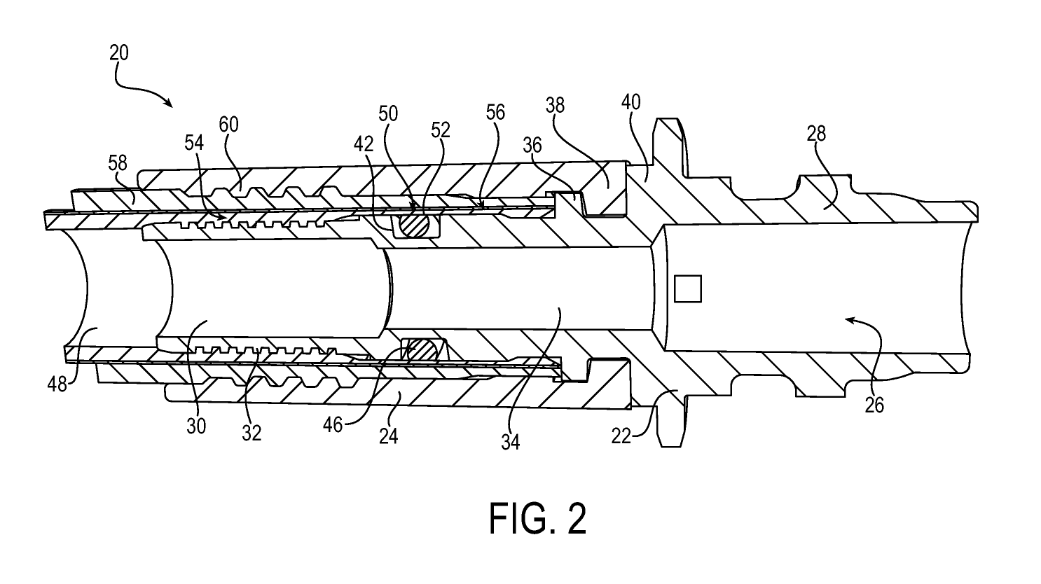

With reference to FIGS. 1 and 2, a hose fitting 20 according to a first embodiment is shown. The hose fitting 20 includes a main fitting body 22 and an outer sleeve 24 that is secured to or fixed around at least a portion of the main fitting body 22. The main fitting body 22 and the outer sleeve 24 are concentrically arranged about a longitudinal axis. The main fitting body 22 and the outer sleeve 24 may be formed of any suitable metal, and stainless steel is an example of a suitable metal. The main fitting body 22 defines a fluid passage 26 extending along the longitudinal axis. The main fitting body 22 includes a female connector 28 that is configured to receive a male connection of a hose (not shown) having a diameter that is smaller than the diameter of the female connector 28. The female connector 28 is arranged at a first end of the main fitting body 22, and an axially extending nipple 30 is arranged at a second end of the main fitting body 22 that is opposite the first end. In an alternative embodiment, the axially extending nipple may be formed on the outer sleeve 24.

The axially extending nipple 30 has a diameter that is less than the outer diameter of the female connector 28, and the axially extending nipple 30 further includes a grooved surface or grooved portion 32 that includes a plurality of grooves axially arranged along at least a portion of the outer diameter of the axially extending nipple 30. The grooved portion 32 may have a profile with shapes that are the same or varying. The profile may have any suitable shapes and examples of suitable shapes include squares, rectangles, triangles, trapezoids, and polygons. The profile may extend partially along the length of the axially extending nipple 30, and the profile may extend along more than half of the entire axial length of the axially extending nipple 30.

The nipple 30 further has a middle portion 34 integrally connected between the grooved portion 32 of the nipple 30 and the female connector 28. The middle portion 34 of the nipple 30 has at least one stop 36 that extends radially outwardly from an outer diameter of the middle portion 34 and toward the outer sleeve 24. The stop 36 is engageable with a hooked end 38 of the outer sleeve 24 such that the hooked end 38 is secured between the stop 36 and a radial wall 40 defined between the female connector 28 and the nipple 30. The hooked end 38 may be press-fitted between the stop 36 and the radial wall 40. The engagement of the stop 36 with the hooked end 38 prevents axial movement of the outer sleeve 24 relative to the main fitting body 22.

The middle portion 34 of the nipple 30 further includes at least one gland 42 defined in the outer diameter of the middle portion 34. The at least one gland 42 is axially spaced from the stop 36 and arranged between the nipple 30 and the stop 36. In an alternative embodiment, the gland may be formed on an inner diameter of the outer sleeve 24. More than one gland may be arranged in the axial direction such that multiple glands may be adjacent each other. The gland 42 may have any suitable shape and when multiple glands are provided, the glands may have the same shape or different shapes. Examples of suitable shapes include a face seal shape (as shown in FIG. 2), a dovetail shape (as shown in FIG. 1), a half dovetail shape, and a triangular shape.

The at least one gland 42 is configured to receive and retain at least one elastomeric seal member 46. The elastomeric seal member 46 may be in any suitable form. For example, the elastomeric seal member 46 may be in the form of an o-ring. More than one elastomeric material may be used and more than one elastomeric seal member 46 may be provided in the at least one gland 42. A back-up ring or a plurality of back-up rings may be provided and the elastomeric seal members may have different sizes. The elastomeric seal member 46 may be formed of any suitable elastomeric material and particularly, an elastomeric material that is suitable for high temperature sealing. Examples of suitable materials that may be used individually or in combination include perfluoroelastomer, fluoroelastomer, propropylene rubber, polydimethylsiloxane, tetrafluoroethylene propylene, fluorosilicone rubber, polytetrafluoroethylene, polyethylenetetrafluoroethylene, and ethylene propylene rubber.

An axially extending tube member 48 is compressed over the elastomeric seal member 46 to form a high temperature sealing region 50. The tube member 48 is radially interposed between the main fitting body 22 and the outer sleeve 24. The tube member 48 extends over the nipple 30 and outwardly from the outer sleeve 24. The tube member 48 extends axially along the longitudinal axis of the hose fitting 20 from the stop 36 to a point past the nipple 30. The entire axial length of the tube member 48 may be longer than the entire axial length of the nipple 30. The tube member 48 extends over the grooved portion 32 and the gland 42 of the main fitting body 22. The tube member 48 extends over the gland 42 such that the tube member 48 is compressed in the area of the elastomeric seal member 46 to create a flat seal surface 52. The thickness of the tube member 48 may be similar to the thickness of the nipple 30, and the tube member 48 may be formed of any material that is suitable for withstanding high temperatures. An example of a suitable material is polytetrafluoroethylene (PTFE).

A low temperature sealing region 54 is defined by compression of the tube member 48 over the grooved portion 32 of the nipple 30. The compression in the high temperature sealing region 50 may be greater than the compression in the low temperature sealing region 54 such that the thickness of the tube member 48 tapers from the nipple 30 toward the female connector 28. Many other configurations of the female connector 28 may be suitable. For example, the hose fitting 20 may have a male connection instead of the female connector 28. The male connection or the female connection may have a flare tube end or a flareless tube end. The hose fitting 20 may have a male or female pipe end, a male or female bulkhead end, a weld end, a beam seal tube end, or a tube swage end. Any of the aforementioned features may be combined. The hose fitting 20 is pre-compressed to a predetermined amount that is selected based on the pressure and temperature conditions of the application for the hose fitting 20. The hose fitting 20 may be compressed using any suitable manufacturing process or processes.

The hose fitting 20 further includes a crimped region 56 in which the main fitting body 22 and the outer sleeve 24 are crimped together to withstand pressure and end load conditions. The crimped region 56 functions as a metal-to-metal crimp joint in which the tube member 48 is highly compressed between the main fitting body 22 and the outer sleeve 24. The low temperature sealing region 54, the crimped region 56, and the high temperature sealing region 50 are sequentially arranged along the longitudinal axis of the hose fitting 20. The sequential order of the regions is dependent on the temperature and pressure in the surrounding environment of the hose fitting 20 and the temperature and pressure of the fluid passing through the hose fitting 20. Any suitable order of the regions may be provided. As shown in FIGS. 1 and 2, the high temperature sealing region 50 is axially arranged between the low temperature sealing region 54 and the crimped region 56. In the embodiment of FIGS. 1 and 2, the low temperature sealing region 54 is arranged to be upstream of the high temperature sealing region 50 and the crimped region 56 relative to the female connector 28. In an alternative embodiment, the crimped region 56 may be arranged to be upstream of the high temperature sealing region 50 and the low temperature sealing region 54.

The hose fitting 20 further includes a braided metal wire 58 that is radially interposed between the main fitting body 22 and the outer sleeve 24. The braided metal wire 58 is radially interposed between the tube member 48 and the outer sleeve 24. The braided metal wire 58 extends axially from the stop 36 and outwardly from the outer sleeve 24 to a point past the nipple 30 such that the braided metal wire 58 extends over the nipple 30. The braided metal wire 58 may have an entire axial length that is longer than the entire axial length of the nipple 30. The tube member 48 may extend along the longitudinal axis to a point past the braided metal wire 58 from the outer sleeve 24 such that the entire axial length of the tube member 48 may be longer than the entire axial length of the braided metal wire 58. The braided metal wire 58 and the tube member 48 may both axially protrude from the outer sleeve 24.

The braided metal wire 58 may be formed of any suitable metal material. An example of a suitable metal material is corrosion resistant steel. The braided metal wire 58 and the outer sleeve 24 are secured together via any suitable securing means. For example, the braided metal wire 58 and the outer sleeve 24 may have a threaded engagement connection. The outer sleeve 24 may have a plurality of teeth 60 that bite into the braided metal wire 58 or are pressed into gaps of the braided metal wire 58. The plurality of teeth 60 extend axially along a portion of the interior diameter of the outer sleeve 24 and the toothed portion of the outer sleeve 24 may axially overlap with the grooved portion 32.

In an exemplary embodiment, the overall compression of the hose fitting 20 occurs between the braided metal wire 58 and the nipple 30. As shown in FIGS. 1 and 2, the compression is shared between the tube member 48 and the elastomeric member 46 that is formed as an o-ring. Using the tube member 48 formed of PTFE and the elastomeric o-ring enables the tube member 48 and the o-ring to inherently function as two springs that are in series with each other in the radial direction. The stiffness of the tube member 48 and the elastomeric o-ring is inversely proportional to the overall temperature of the environment, which is a combination of the ambient temperature and the temperature of the fluid passing through the hose fitting 20.

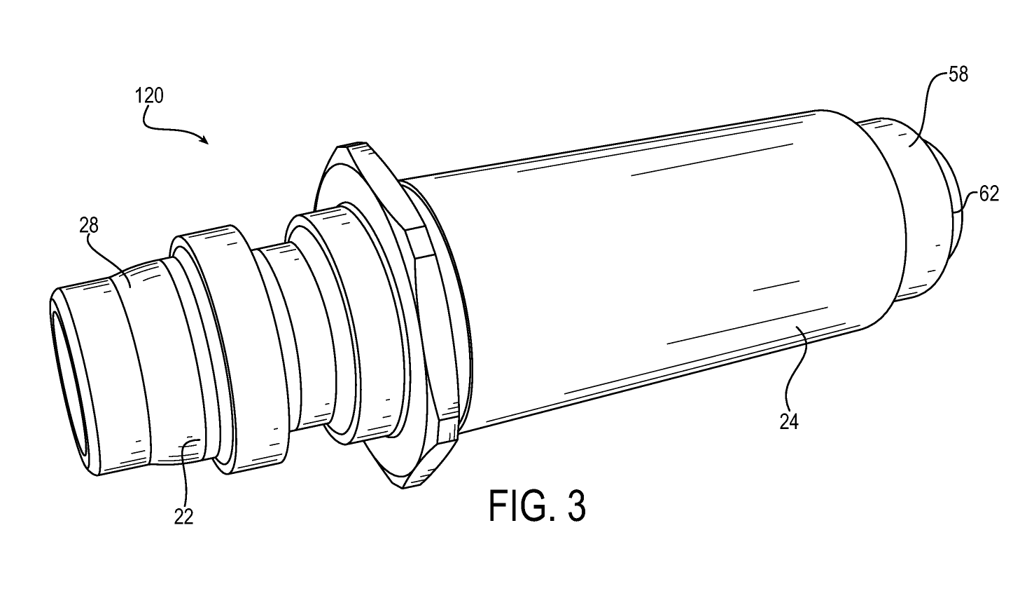

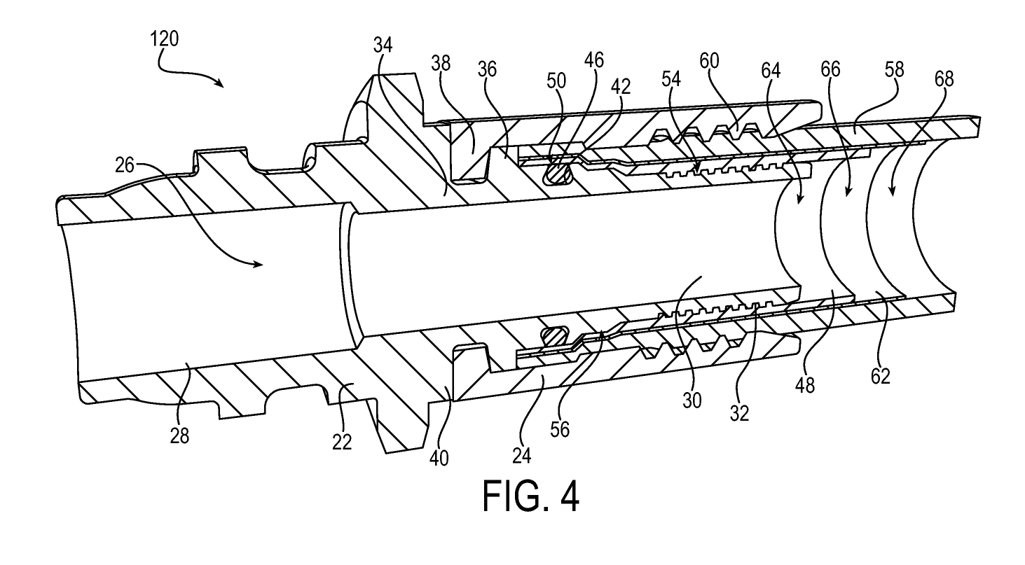

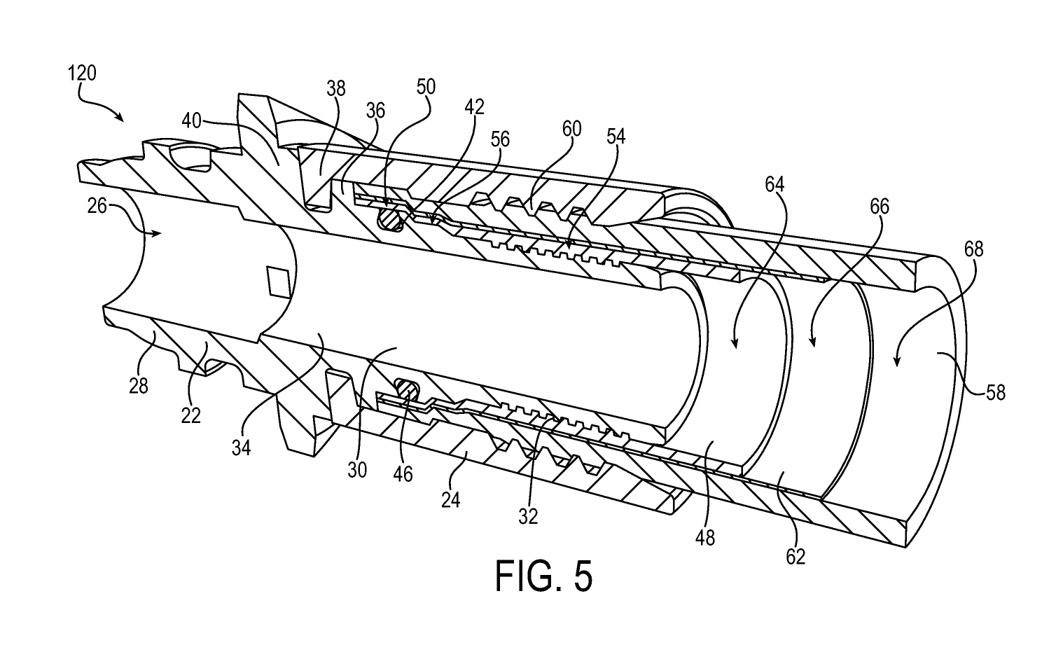

Referring now to FIGS. 3-5, a second exemplary embodiment of the hose fitting 120 is shown, in which the hose fitting 120 further includes a thin film tape layer 62. The hose fitting 120 includes the main fitting body 22 defining the fluid passage 26 and the outer sleeve 24 that is secured around the main fitting body 22. Both the main fitting body 22 and the outer sleeve 24 may be formed of any suitable metal material. The main fitting body 22 includes the female connector 28 and the axially extending nipple 30 having the grooved portion 32 formed on the outer diameter thereof. The middle portion 34 of the nipple 30 is integrally connected between the grooved portion 32 of the nipple 30 and the female connector 28. The middle portion 34 of the nipple 30 includes the at least one stop 36 that engages the hooked end 38 of the outer sleeve 24, and the at least one gland 42. The gland 42 receives and retains the elastomeric seal member 46 that is in the form of an o-ring. The hose fitting 120 further includes the axially extending tube member 48 that is formed of PTFE.

Similarly as in the previous embodiment, the axially extending tube member 48 is compressed over the elastomeric seal member 46 to form the high temperature sealing region 50, and the low temperature sealing region 54 is defined by compression of the tube member 48 over the grooved portion 32. In the second embodiment shown in FIG. 3-5, the crimped region 56 is axially interposed between the high temperature sealing region 50 and the low temperature sealing region 54, such that the low temperature sealing region 54 is arranged to be upstream of the crimped region 56 and the high temperature sealing region 50 relative to the female connector 28. In an alternative embodiment, the high temperature sealing region 50 may be arranged to be upstream of the crimped region 56 and the low temperature sealing region 54. The hose fitting 120 further includes a braided metal wire 58 that is radially interposed between the tube member 48 and the outer sleeve 24. The braided metal wire 58 extends axially from a point past the nipple 30 to the stop 36 such that the braided metal wire 58 extends over the nipple 30. The braided metal wire 58 extends axially from the stop 36 to a point past the tube member 48. The outer sleeve 24 may have the plurality of teeth 60 that bite into the braided metal wire 58.

The hose fitting 120 further includes a film tape layer 62 that is radially interposed between the braided metal wire 58 and the tube member 48. The film tape layer 62 has an entire axial length that is longer than the entire axial length of the tube member 48 and shorter than the entire axial length of the braided metal wire 58. The tube member 48, the film tape layer 62, and the braided metal wire 58 all axially protrude from the stop 36 and axially outwardly from the outer sleeve 24. The tube member 48, the film tape layer 62, and the braided metal wire 58 may protrude incrementally from the outer sleeve 24, such that the axial length of an overlapping area 64 between all of the tube member 48, the film tape layer 62, and the braided metal wire 58 is geometrically similar to the axial length of an overlapping area 66 between only the film tape layer 62 and the braided metal wire 58. The axial lengths of the overlapping areas 64, 66 are also geometrically similar to the length of a non-overlapping area 68 of the braided metal wire 58. The film tape layer 62 may have any suitable thickness and the thickness may be less than the thickness of the braided metal wire 58 and/or the thickness of the tube member 48.

The film tape layer 62 may be formed of any suitable material and an example of a suitable material is polyimide. The polyimide film tape layer 62 may have one layer or more than one layer. The film tape layer 62 may include multiple layers that have the same or different thicknesses. Using the polyimide film tape layer 62 is advantageous since the PTFE tube member 48 may extrude through gaps in the braided metal wire 58 at high temperature conditions. The polyimide tape layer 62 reduces the tube extrusion through the gaps of the braided metal wire 58. The polyimide film tape layer 62 or plurality of tape layers may be winded over the PTFE tube member 48 with a spiral orientation. In an embodiment having multiple polyimide film tape layers, the layers may be formed to have orientations that are in the same direction or in opposite directions. The polyimide film tape layer 62 may be configured to have any suitable amount of overlap coverage over the braided metal wire 58. For example, the overlap coverage of the polyimide film tape layer 62 over the braided metal wire 58 may be between 0% when no tape is used and 50%.

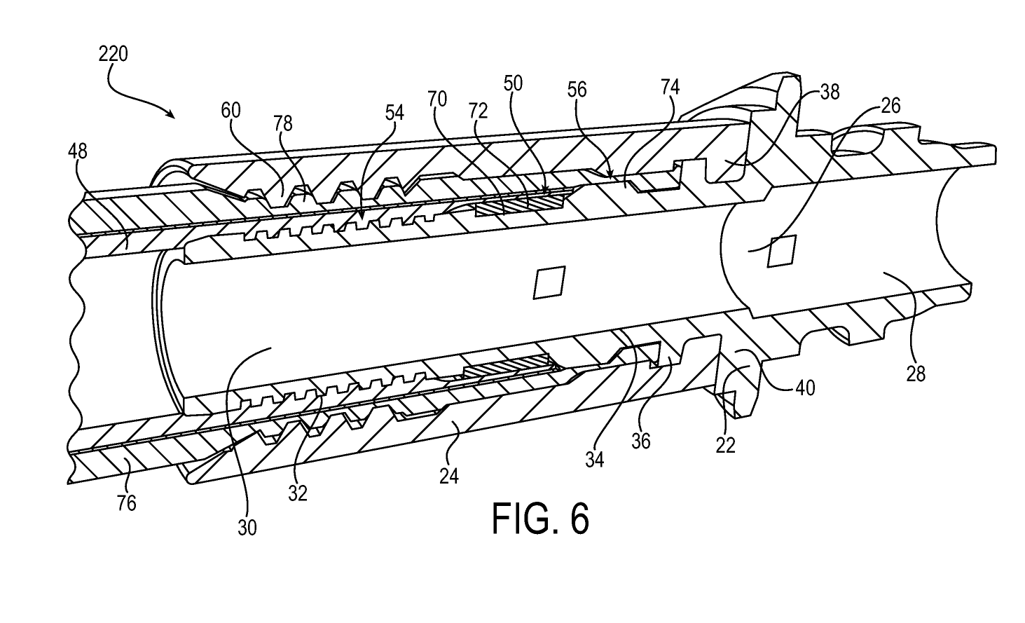

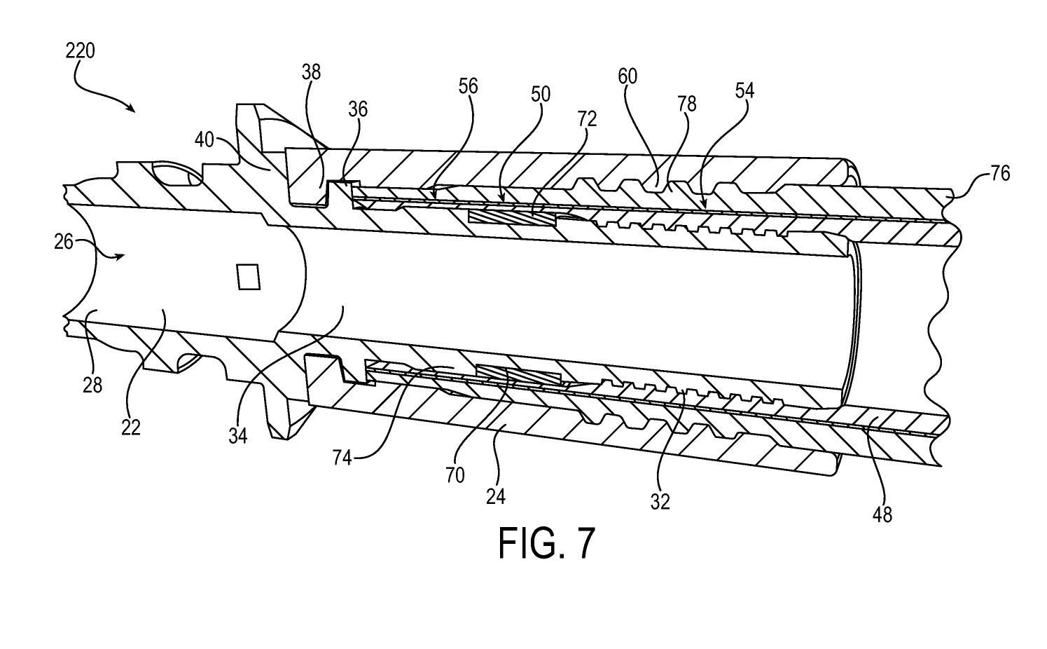

Referring now to FIGS. 6 and 7, a third exemplary embodiment of the hose fitting 220 is shown, in which the hose fitting 220 includes a shallow recess 70 and the elastomeric seal member is in the form of a flat gasket 72. The hose fitting 220 includes the main fitting body 22 and the outer sleeve 24 that is secured or fixed around at least a portion of the main fitting body 22. The main fitting body 22 includes the fluid passage 26, the female connector 28, and the axially extending nipple 30 having the grooved portion 32, and the middle portion 34 of the nipple 30 integrally connected between the grooved portion 32 of the nipple 30 and the female connector 28. The middle portion 34 has the at least one stop 36 that extends radially outwardly from an outer diameter of the middle portion 34 and is engageable with the hooked end 38 of the outer sleeve 24.

The middle portion 34 of the nipple 30 further includes at least one shallow recess 70 defined in the outer diameter of the middle portion 34. The at least one shallow recess 70 is axially spaced from the stop 36 and adjacent the nipple 30. More than one shallow recess 70 may be arranged in the axial direction such that a plurality of shallow recesses are each adjacent each other. The shallow recess 70 is configured to receive and retain the at least one elastomeric seal member that is in the form of the flat gasket 72. The flat gasket 72 may accommodate the entire space or area of the shallow recess 70. More than one flat gasket may be used in each recess and the flat gaskets may have the same lengths, diameters, and thicknesses, or different lengths, diameters, and thicknesses.

The flat gasket 72 or plurality of flat gaskets may be configured to be at least one of seamless, full faced, or the gaskets could be segmented and overlapping. The flat gasket 72 may be formed of a single layer or a plurality of layers. The flat gasket 72 may be formed of any suitable elastomeric material and particularly, an elastomeric material that is suitable for high temperature sealing. Examples of suitable materials that may be used individually or in combination include perfluoroelastomer, fluoroelastomer, propropylene rubber, polydimethylsiloxane, tetrafluoroethylene propylene, fluorosilicone rubber, polytetrafluoroethylene, polyethylenetetrafluoroethylene, and ethylene propylene rubber. The flat gasket 72 may also include filler materials that include at least one of metal strips or graphite.

The axially extending PTFE tube member 48 is compressed over the flat gasket 72 to form the high temperature sealing region 50. The low temperature sealing region 54 is defined by compression of the tube member 48 over the grooved portion 32 comparably as in previous embodiments. The compression in the high temperature sealing region 50 may be greater than the compression in the low temperature sealing region 54 such that the thickness of the tube member 48 tapers from the nipple 30 toward the female connector 28. The crimped region 56 is arranged between the high temperature sealing region 50 and the stop 36, such that the high temperature sealing region 50 is axially arranged between the low temperature sealing region 54 and the crimped region 56. The crimped region 56 may be defined by a radially protruding peripheral surface or step 74 of the main fitting body 22 that extends toward the outer sleeve 24. The main fitting body 22 and the outer sleeve 24 are crimped together. The crimped region 56 may be arranged to be upstream of the high temperature sealing region 50 and the low temperature sealing region 54 or the crimped region 56 may be arranged to be downstream of the high temperature sealing region 50 and the low temperature sealing region 54.

The hose fitting 220 further includes a braided metal wire 76 formed of corrosion resistant steel. The braided metal wire 76 is radially interposed between the tube member 48 and the outer sleeve 24 and the braided metal wire 76 may extend from the stop 36. The tube member 48 may extend from the radially protruding peripheral surface 74 of the main fitting body 22 such that the braided metal wire 76 extends further into the outer sleeve 24. The braided metal wire 76 and the tube member 48 may both axially protrude from the outer sleeve 24. The braided metal wire 76 and the outer sleeve 24 are secured together via meshing engagement in which the outer sleeve 24 has the plurality of teeth 60 that meshingly engage with a plurality of teeth 78 of the braided metal wire 76. The plurality of teeth 60 may extend axially along a portion of the interior diameter of the outer sleeve 24 and the plurality of teeth 78 may extend axially along a portion of the outer diameter of the braided metal wire 76. The length of the meshing engagement between the teeth may axially overlap with the grooved portion 32 of the nipple 30.

The overall compression of the hose fitting 220 occurs between the braided metal wire 76 and the nipple 30. As shown in FIGS. 6 and 7, the compression is shared between the tube member 48 and the flat gasket 72. Using the tube member 48 formed of PTFE and the elastomeric flat gasket 72 enables the tube member 48 and the flat gasket 72 to function as a spring under two fixed surfaces, or a plurality of spring sets that are axially spaced and have two springs that are in series with each other in a radial direction between the braided metal wire 76 and the nipple 30. The stiffness of the tube member 48 and the elastomeric flat gasket 72 is inversely proportional to the overall temperature, which may be a combination of the ambient temperature and the temperature of the fluid passing through the hose fitting 220.

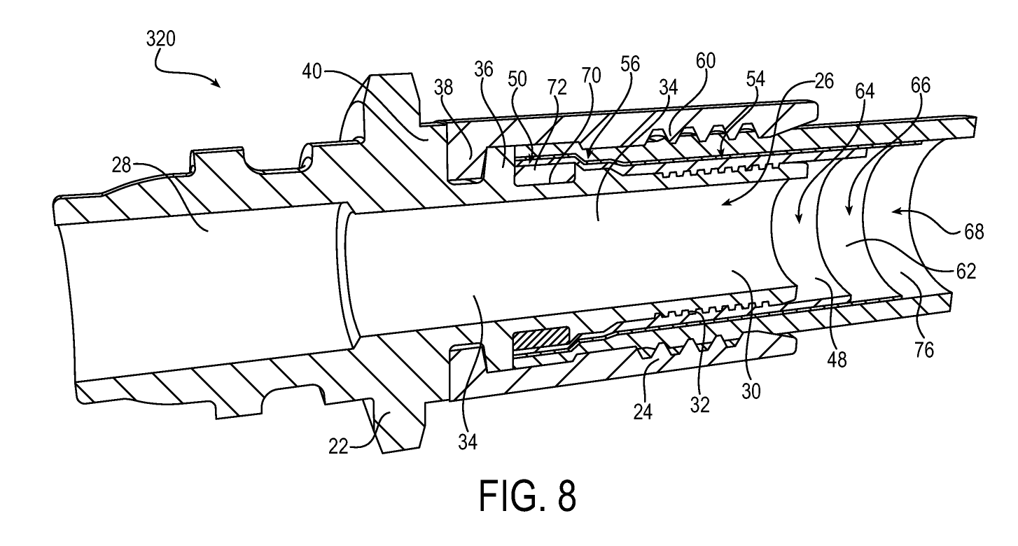

Referring now to FIG. 8, a fourth embodiment of the hose fitting 320 is shown, in which the hose fitting 320 includes the flat gasket seal 72 and the thin film tape layer 62. The hose fitting 320 includes the main fitting body 22 defining the fluid passage 26 and the outer sleeve 24 that is secured around at least a portion of the main fitting body 22. Both the main fitting body 22 and the outer sleeve 24 may be formed of any suitable metal material. The main fitting body 22 includes the female connector 28 and the axially extending nipple 30 having the grooved portion 32 formed on the outer diameter thereof. The middle portion 34 of the nipple 30 is integrally connected between the grooved portion 32 of the nipple 30 and the female connector 28. The middle portion 34 includes the at least one stop 36 that engages the hooked end 38 of the outer sleeve 24, and at least one shallow recess 70 that is defined in an outer diameter of the nipple 30. The shallow recess 70 is defined on one side by the stop 36 and the shallow recess 70 is adjacent the stop 36. The shallow recess 70 receives and retains the elastomeric flat gasket 72 such that the flat gasket 72 abuts against the stop 36. The flat gasket 72 may have an outer diameter that is greater than the diameter of the grooved portion 32 of the nipple 30. The hose fitting 320 further includes the axially extending tube member 48 that is formed of PTFE.

The axially extending tube member 48 is compressed over the elastomeric flat gasket 72 to form the high temperature sealing region 50 and the low temperature sealing region 54 is defined by compression of the tube member 48 over the grooved portion 32. The crimped region 56 is axially arranged between the high temperature sealing region 50 and the low temperature sealing region 54. The hose fitting 320 further includes a braided metal wire 76 that is radially interposed between the tube member 48 and the outer sleeve 24. The braided metal wire 76 extends from the stop 36 and axially outwardly from the outer sleeve 24 such that the braided metal wire 76 extends over the nipple 30. The entire axial length of the braided metal wire 76 may be greater than the entire axial length of the tube member 48. The outer sleeve 24 may have the plurality of teeth 60 that bite into the braided metal wire 76.

The hose fitting 320 further includes the film tape layer 62 that is radially interposed between the braided metal wire 76 and the tube member 48. The film tape layer 62 may have an entire axial length that is longer than the entire axial length of the tube member 48 and shorter than the entire axial length of the braided metal wire 76. The tube member 48, the film tape layer 62, and the braided metal wire 76 all axially protrude from the stop 36 and axially outwardly from the outer sleeve 24. The tube member 48, the film tape layer 62, and the braided metal wire 76 may protrude incrementally from the outer sleeve 24, such that the axial length of the overlapping area 64 between all of the tube member 48, the film tape layer 62, and the braided metal wire 76 is geometrically similar to the axial length of the overlapping area 66 between only the film tape layer 62 and the braided metal wire 76. The axial lengths of the overlapping areas 64, 66 are also geometrically similar to the length of the non-overlapping area 68 of the braided metal wire 76. The film tape layer 62 may have any suitable thickness and the thickness may be less than the thickness of the braided metal wire 76 and the thickness of the tube member 48. The film tape layer 62 may be formed of polyimide.

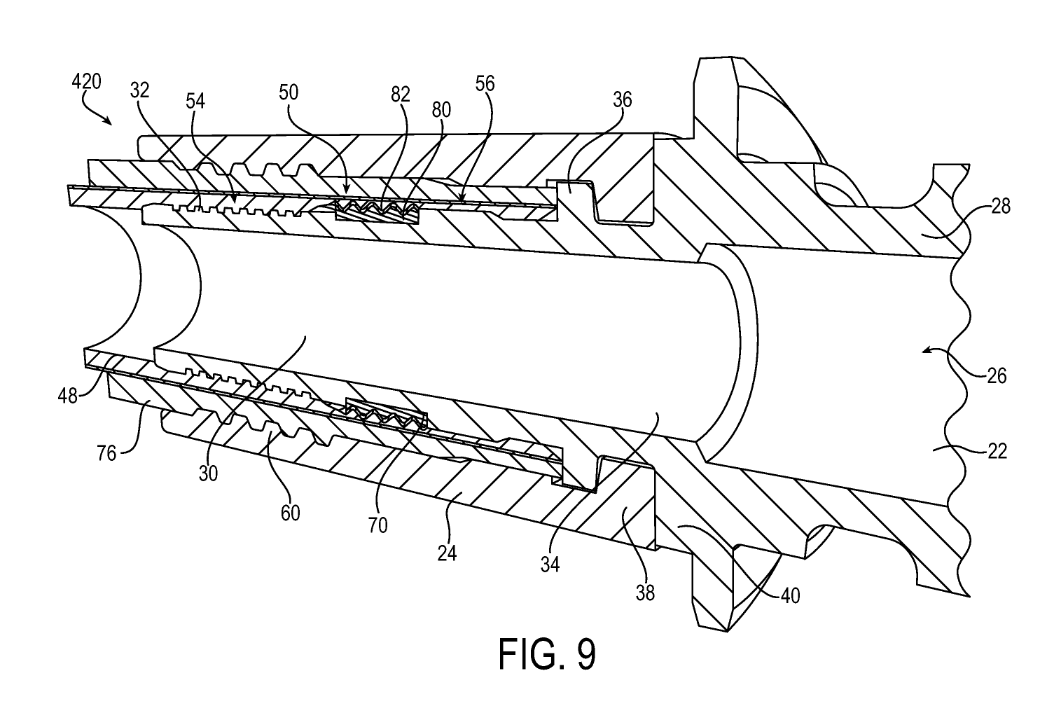

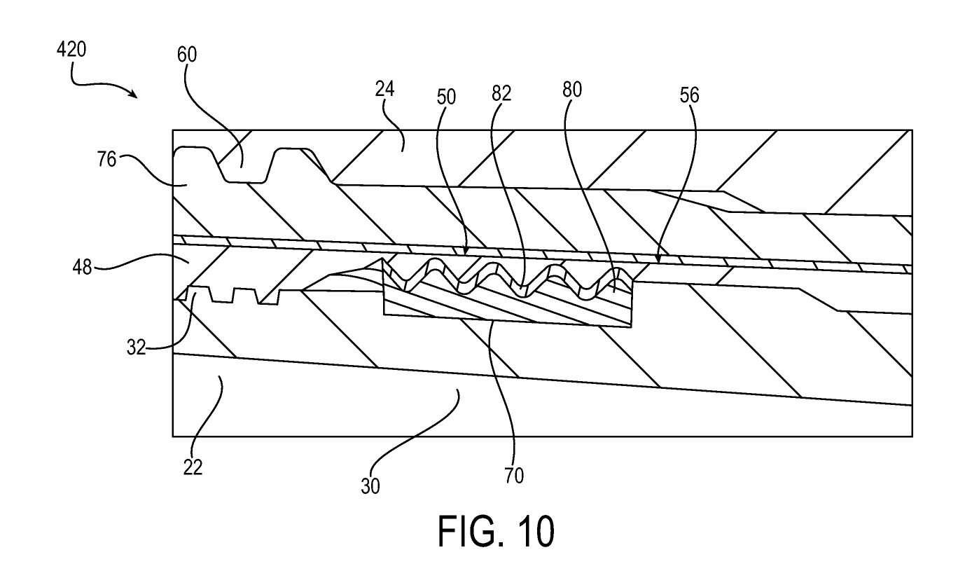

Referring now to FIGS. 9 and 10, a fifth embodiment of the hose fitting 420 is shown, in which the hose fitting 420 includes a corrugated gasket 80 and a corrugated ferrule 82. The hose fitting 420 includes the main fitting body 22, the outer sleeve 24, the PTFE tube member 48, and the braided metal wire 76. The PTFE tube member 48 and the braided metal wire 76 extend axially from the stop 36 of the main fitting body 22 and outwardly from the outer sleeve 24. The entire axial length of the PTFE tube member 48 may be longer than the entire axial length of the braided metal wire 76. The hose fitting 420 further includes the shallow recess 70 defined in the outer diameter of the nipple 30 of the main fitting body 22. The shallow recess 70 is adjacent the grooved portion 32. The shallow recess 70 receives and retains the elastomeric corrugated gasket 80 that fills the entire area of the shallow recess 70. The low temperature sealing region 54 is defined by compression of the tube member 48 over the grooved portion 32, and the crimped region 56 is adjacent the stop 36.

The high temperature sealing region 50 further includes the ferrule 82 that is radially interposed between the corrugated gasket 80 and the tube member 48. The ferrule 82 may be flat or corrugated in the axial direction. The corrugation of the ferrule 82 is complementary to the corrugation of the corrugated gasket 80. The ferrule 82 may radially protrude from the shallow recess 70 such that the ferrule 82 has a diameter that is larger than the diameter of the grooved portion 32. The ferrule 82 may have any suitable dimensions. The ferrule 82 may have a thickness that is less than the thickness of the corrugated gasket 80 and the axial length of the ferrule 82 may be the same or similar to the axial length of the corrugated gasket 80. The ferrule 82 is configured to support polymer flow or movement of the PTFE tube member 48 and the elastomeric corrugated gasket 80 during elevated temperature conditions of the surrounding environment. The ferrule 82 has a very thin wall thickness with a longitudinal slit. The ferrule 82 may be formed of any suitable material that has a high coefficient of thermal expansion.

Other embodiments of the hose fitting may use different combinations of the aforementioned structural features. The low temperature sealing region, the high temperature sealing region, and the crimped region may be arranged in any suitable sequential order depending on the application for the hose fitting. The hose fitting is advantageous because all of the components are arranged as a single pressed fitting part that can be easily connected to existing hoses. Furthermore, the features of the hose fitting may be selected based on the pressure and temperature conditions of the intended application. The hose fitting may be suitable to withstand high temperatures of over 550 degrees Fahrenheit or low temperatures of around −65 degrees Fahrenheit, without requiring the use of manifold, heat shields, mounting hardware, or other additional heating or cooling components. When used in an aircraft engine application, the hose fitting allows for higher combustion temperatures enabling increased fuel burn efficiency and a lower life cycle cost.

A hose fitting includes a main fitting body defining a fluid passage and an outer sleeve that surrounds at least a portion of the main fitting body. A crimped region is defined by the main fitting body and the outer sleeve being crimped toward each other. A nipple having a grooved portion is provided. A tube member is radially interposed between the main fitting body and the outer sleeve, and a low temperature sealing region is defined by the tube member being compressed over the grooved portion of the nipple. An elastomeric seal member is radially interposed between the main fitting body and the tube member, and a high temperature sealing region is defined by the tube member being compressed over the elastomeric seal member. The crimped region, the low temperature sealing region, and the high temperature sealing region are sequentially arranged in an axial direction.

The hose fitting may include a braided metal wire that is radially interposed between the main fitting body and the outer sleeve, and the crimped region includes engagement between at least one of the axially extending nipple and the braided wire, and the braided wire and the outer sleeve.

The axially extending nipple may have a grooved portion with a profile with shapes that are at least one of squares, rectangles, triangles, trapezoids, or polygons.

The hose fitting may include at least one gland formed in the main fitting body or in the outer sleeve.

The at least one gland may have a shape that is face seal, dovetail, half dovetail, or triangular.

The elastomeric seal member may include at least one o-ring retained within the at least one gland.

The crimped region may be axially interposed between the high temperature sealing region and the low temperature sealing region.

The hose fitting may include a flat recess arranged on an exterior surface of the main fitting body.

The elastomeric seal member may include at least one gasket that is flat or corrugated and arranged in the flat recess and radially interposed between the main fitting body and the tube member.

The high temperature sealing region may be axially interposed between the crimped region and the low temperature sealing region.

The low temperature sealing region may be upstream of the high temperature sealing region and the crimped region.

The hose fitting may include a corrugated ferrule that is radially interposed between the at least one gasket and the tube member.

The hose fitting may include a film tape layer that is arranged over the tube member.

The film tape layer may be formed of polyimide.

The tube member may be formed of polytetrafluoroethylene.

The elastomeric seal member may be formed of at least one of perfluoroelastomer, fluoroelastomer, propropylene rubber, polydimethylsiloxane, tetrafluoroethylene propylene, fluorosilicone rubber, polytetrafluoroethylene, polyethylenetetrafluoroethylene, or ethylene propylene rubber.

A hose fitting includes a main fitting body defining an interior fluid passage and having an exterior surface, and the exterior surface has a nipple groove and at least one gland axially spaced from the nipple groove. The hose fitting includes an outer sleeve arranged around at least a portion of the main fitting body, the outer sleeve surrounding the nipple groove and the at least one gland. The hose fitting includes a tube member radially interposed between the main fitting body and the outer sleeve, and the tube member extends over the at least one gland. A low temperature sealing region is defined by compression of the tube member over the axially extending nipple. At least one elastomeric o-ring is arranged within the at least one gland, and a high temperature sealing region is defined by compression of the tube member over the at least one elastomeric o-ring. The hose fitting includes a braided metal wire radially interposed between the tube member and the outer sleeve, and a crimped region is axially interposed between the lower temperature sealing region and the high temperature sealing. The crimped region is defined by the outer sleeve, the first body hose and the braided metal wire being crimped together.

The at least one gland may have a shape that is face seal, dovetail half dovetail, or triangular.

A hose fitting includes a main fitting body defining an interior fluid passage and having an exterior surface, and the exterior surface has a nipple groove and at least one shallow recess axially spaced from the nipple groove. The hose fitting includes an outer sleeve arranged around at least a portion of the main fitting body, the outer sleeve surrounding the nipple groove and the at least one shallow recess. The hose fitting includes a tube member radially interposed between the main fitting body and the outer sleeve, the tube member extending over the at least one shallow recess, wherein a low temperature sealing region is defined by the tube member being compressed over the axially extending nipple. At least one gasket is arranged within the at least one shallow recess, and a high temperature sealing region is defined by compression of the tube member over the at least one gasket. A braided metal wire is radially interposed between the tube member and the outer sleeve. A crimped region is defined by the outer sleeve, the first body hose and the braided metal wire being crimped together, and the high temperature sealing region is axially interposed between the crimped region and the low temperature sealing region.

The at least one gasket may be corrugated and a corrugated ferrule may be arranged between the at least one gasket and the tube member.

The at least one gasket may be at least one of flat, seamless, full faced, corrugated, or segmented.

A method of manufacturing a hose fitting includes providing a main fitting body having an axially extending nipple, forming a grooved surface and at least one gland on the axially extending nipple, securing an outer sleeve to the main fitting body, radially interposing a tube member between the main fitting body and the outer sleeve, inserting an elastomeric sealing member in the at least one gland, compressing the tube member over the nipple to form a low temperature sealing region over the grooved surface and a high temperature sealing region over the at least one gland, and crimping the main fitting body and the outer sleeve to form a crimped region. The low temperature sealing region, the high temperature sealing region, and the crimped region are sequentially arranged in an axial direction.

The method may further include crimping the main fitting body and the outer sleeve at an axial location between the grooved surface and the at least one gland to form the crimped region between low temperature sealing region and the high temperature sealing region.

The method may further include crimping the main fitting body and the outer sleeve at an axial location that is downstream or upstream from the at least one gland and the grooved surface to form the crimped region downstream or upstream from the high temperature sealing region and the low temperature sealing region.

The method may further include radially interposing a braided metal wire between the tube member and the outer sleeve, and radially interposing a polyimide thin film tape layer between the tube member and the braided metal wire.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hose fitting comprising:
a main fitting body defining a fluid passage;
an outer sleeve that surrounds at least a portion of the main fitting body, wherein a crimped region is defined by the main fitting body and the outer sleeve being crimped toward each other;
a nipple having a grooved portion;
a tube member radially interposed between the main fitting body and the outer sleeve, wherein a low temperature sealing region is defined by the tube member being compressed over the grooved portion of the nipple; and
an elastomeric seal member radially interposed between the main fitting body and the tube member, wherein a high temperature sealing region is defined by the tube member being compressed over the elastomeric seal member,
wherein the crimped region, the low temperature sealing region, and the high temperature sealing region are sequentially arranged in an axial direction along the hose fitting.

2. The hose fitting according to claim 1 further comprising a braided wire that is radially interposed between the main fitting body and the outer sleeve, wherein the crimped region includes engagement between at least one of the nipple and the braided wire, and the braided wire and the outer sleeve.

3. The hose fitting according to claim 1, wherein the nipple is formed on the main fitting body and the grooved portion has a profile with shapes that are at least one of squares, rectangles, triangles, trapezoids, or polygons.

4. The hose fitting according to claim 1 further comprising at least one gland formed in the main fitting body or in the outer sleeve.

5. The hose fitting according to claim 4, wherein the at least one gland has a shape that is face seal, dovetail, half dovetail, or triangular.

6. The hose fitting according to claim 4, wherein the elastomeric seal member includes at least one o-ring retained within the at least one gland.

7. The hose fitting according to claim 4, wherein the low temperature sealing region is upstream of the crimped region and the high temperature sealing region.

8. The hose fitting according to claim 1 further comprising a flat recess arranged on an exterior surface of the main fitting body.

9. The hose fitting according to claim 8, wherein the elastomeric seal member includes at least one gasket, the elastomeric seal being arranged in the flat recess and radially interposed between the main fitting body and the tube member.

10. The hose fitting according to claim 9, wherein the at least one gasket is at least one of flat, seamless, full faced, corrugated, or segmented.

11. The hose fitting according to claim 9 further comprising a corrugated ferrule, wherein the at least one gasket is corrugated and the corrugated ferrule is radially interposed between the at least one gasket and the tube member.

12. The hose fitting according to claim 8, wherein the high temperature sealing region is axially interposed between the crimped region and the low temperature sealing region.

13. The hose fitting according to claim 1 further comprising a film tape layer that is arranged over the tube member.

14. The hose fitting according to claim 13, wherein the film tape layer is formed of polyimide.

15. The hose fitting according to claim 1, wherein the tube member is formed of polytetrafluoroethylene.

16. The hose fitting according to claim 1, wherein the elastomeric seal member is formed of at least one of perfluoroelastomer, fluoroelastomer, propropylene rubber, polydimethylsiloxane, tetrafluoroethylene propylene, fluorosilicone rubber, polytetrafluoroethylene, polyethylenetetrafluoroethylene, or ethylene propylene rubber.

17. A method of manufacturing a hose fitting, the method comprising:
providing a main fitting body having a nipple;
forming a grooved surface and at least one gland on the nipple;
securing an outer sleeve to the main fitting body;
radially interposing a tube member between the main fitting body and the outer sleeve;
inserting an elastomeric sealing member in the at least one gland;
compressing the tube member over the nipple to form a low temperature sealing region over the grooved surface and a high temperature sealing region over the at least one gland; and
crimping the main fitting body and the outer sleeve to form a crimped region, wherein the low temperature sealing region, the high temperature sealing region, and the crimped region are sequentially arranged in an axial direction.

18. The method of claim 17 further comprising crimping the main fitting body and the outer sleeve at an axial location between the grooved surface and the at least one gland to form the crimped region between the low temperature sealing region and the high temperature sealing region.

19. The method of claim 17 further comprising crimping the main fitting body and the outer sleeve at an axial location that is downstream or upstream from the at least one gland and the grooved surface to form the crimped region downstream or upstream from the high temperature sealing region and the low temperature sealing region.

20. The method of claim 17 further comprising:
radially interposing a braided metal wire between the tube member and the outer sleeve; and
radially interposing a polyimide thin film tape layer between the tube member and the braided metal wire.
